(19) United States
(12) Patent Application Publication
(10) Pub. No.: US 2008/0294612 A1
(43) Pub. Date: Nov. 27, 2008

(54) Method For Generating A Representation Of A Query

(75) Inventor: Andrew Wiles, Nottingham (GB)

Correspondence Address: PRASS LLP, 2661 Riva Road, Bldg. 1000, Suite 1044, ANNAPOLIS, MD, 21401, US

(73) Assignee: iT-Workplace, Nottingham (GB)

(21) Appl. No.: 11/751,919

(22) Filed: May 22, 2007

(51) Int. Cl. G06F 17/30

(52) U.S. Cl. 707/4; 707/E17.014

(57) ABSTRACT

This invention relates to a computer-based method for generating a representation of a query for use in performing said query. The method comprises the steps of: retrieving data from a data source; displaying said retrieved data in a plurality of cells, each of said plurality of cells being associated with a cell reference and being capable of containing data from said data source, each cell reference being associated with an expression formulated in a predetermined query language; receiving data indicative of an output cell selected from said plurality of cells; receiving data indicative of a formula for insertion in said selected output cell, said formula comprising a plurality of input cell references, each relating to one of said cells; and converting said formula into a calculation query comprising an output expression and a plurality of input expressions by replacing each of said input cell references in said formula by its associated expression, whereby to generate a representation of said calculation query.

### FIELD OF THE INVENTION

The present invention relates to a method for generating a representation of a query for use in performing the query, the query being formulated in a query language, such as the multidimensional expressions (MDX) language. The invention also relates to apparatus and computer software arranged to conduct the method of the invention.

### BACKGROUND OF THE INVENTION

A multidimensional database (MDB) is a type of database that is typically used for collecting and combining large volume of data from a plurality of data sources. A multidimensional database uses the idea of a data cube to represent several dimensions of data, the cube comprising a number of cells which may be filled with data.

A multidimensional database may for instance store sales and inventory data which may be used in sales and marketing applications. For example, a three-dimensional database may contain the sales figures of a company for its different products A to E in different geographic areas during different time periods. In that case, the dimensions of the multidimensional database are product, geographic sales area and time period. A cell of the data cube may comprise a data value which may for instance corresponds to the number of products A sold in a specific geographic area during a specific time period. Examples of multidimensional database software products are Hyperion®'s Essbase™ and Microsoft's SQL Server Analysis Services.

Online analytical processing (OLAP) software enables a user to collect, store, extract and manipulate multidimensional data from the multidimensional database using a query language such as multidimensional expressions (MDX) language. Using MDX query statements, a user may request data from the multidimensional database, such as the amount of a specific product sold by his company in a specific geographic area for a specific month, to be extracted and displayed on a user interface in a spreadsheet document for instance. Since MDX is also a calculation language, the user is able to create a member in the spreadsheet document which is defined using a corresponding calculation formula, in the form of MDX expressions. When processed, the MDX expressions return a single data value.

In the MDX language, multidimensional data is described using different data types, such as dimension, hierarchy, level, member, tuple and set. As mentioned above, a data cube comprises several dimensions, each dimension being a category of data within the cube. A dimension may be specified/written in the MDX language as [Dimension Name], e.g. [Time], [Product] and [Customer]. A hierarchy is a hierarchical structure of data within a dimension of the data cube. A dimension may contain one or more hierarchies, a hierarchy being specified in MDX as [Dimension Name].[Hierarchy Name]. A hierarchy comprises a number of levels, a level being specified in MDX as [Dimension Name].[Hierarchy Name].[Level Name]. A level comprises members, a member being specified in MDX as [Dimension Name].[Hierarchy Name].[Level Name].[Member Name]. A tuple is a collection of one or more members from different hierarchies which corresponds to a set of coordinates in the cube defining an intersection cell in the cube. A tuple can be specified in MDX by enumerating the members. A set is a collection of tuples which corresponds to a collection of points in the cube. A set may be specified in MDX by enumerating the tuples. Alternatively, a hierarchy, a level, a member, a tuple and a set can be returned using an MDX function.

The creation of a calculation formula, in the form of MDX expressions that use the above data types, can prove complex and cumbersome since a formula may comprise a combination of many data types.

### SUMMARY OF THE INVENTION

According to an aspect of the present invention there is provided a computer-based method for generating a representation of a query for use in performing said query, the method comprising the steps of:
(a) retrieving data from a data source;
(b) displaying said retrieved data in a plurality of cells, each of said plurality of cells being associated with a cell reference and being capable of containing data from said data source, each cell reference being associated with an expression formulated in a predetermined query language;
(c) receiving data indicative of an output cell selected from said plurality of cells;
(d) receiving data indicative of a formula for insertion in said selected output cell, said formula comprising a plurality of input cell references, each relating to one of said cells; and
(e) converting said formula into a calculation query comprising an output expression and a plurality of input expressions by replacing each of said input cell references in said formula by its associated expression, whereby to generate a representation of said calculation query.

Embodiments of this invention generally provide a method for entering an otherwise cumbersome query in a predetermined query language using cell references identified by a user, for example in a spreadsheet document, and of dynamically creating an output expression in the predetermined query language by replacing the cell references with their corresponding input expressions.

Since the cell references are far shorter than the often awkward expressions making up a query, embodiments of the invention thus provide a means for generating a far simpler representation of a query. This enables the user to compose calculation expressions without being distracted by the complexity of the predetermined query language.

U.S. Pat. No. 7,120,866 describes an architecture for integrating spreadsheet functionality into tables commonly used in word processing programs and HTML documents. The architecture presents a table user interface (UI) that resembles a table/grid when not being edited and adds spreadsheet elements to the table/grid when being edited. The architecture has a spreadsheet functionality manager to manage the spreadsheet functions for the table, such as recalculation, formula handling, sorting, referencing, etc. The user is able to enter a formula (such as a summation formula) in a cell of the table or in a free floating field disposed somewhere within a document that the user is creating using a reference edit operation, and is then able to select an array of cells so that the cell references are entered into the formula. The formula is then calculated on the basis of the values of the cells which are entered in the formula. This document does not describe a mechanism for picking up cell references and automatically converting them in a calculation query, as per the invention.

The invention also relates to apparatus and computer software arranged to conduct the method of the invention.

Further features and advantages of the invention will become apparent from the following description of preferred embodiments of the invention, given by way of example only, which is made with reference to the accompanying drawings.

### BRIEF DESCRIPTION OF THE DRAWINGS

FIG. 1 illustrates a computer system arranged to perform a method in accordance with an embodiment of the present invention;

FIG. 2 is a flow diagram describing a computer-based method implemented by the computer system of FIG. 1 in accordance with an embodiment of the present invention;

FIG. 3 shows a screen display of a user interface in accordance with an embodiment of the present invention; and

FIG. 4 shows a screen display of a user interface in accordance with an embodiment of the present invention.

### DETAILED DESCRIPTION OF THE INVENTION

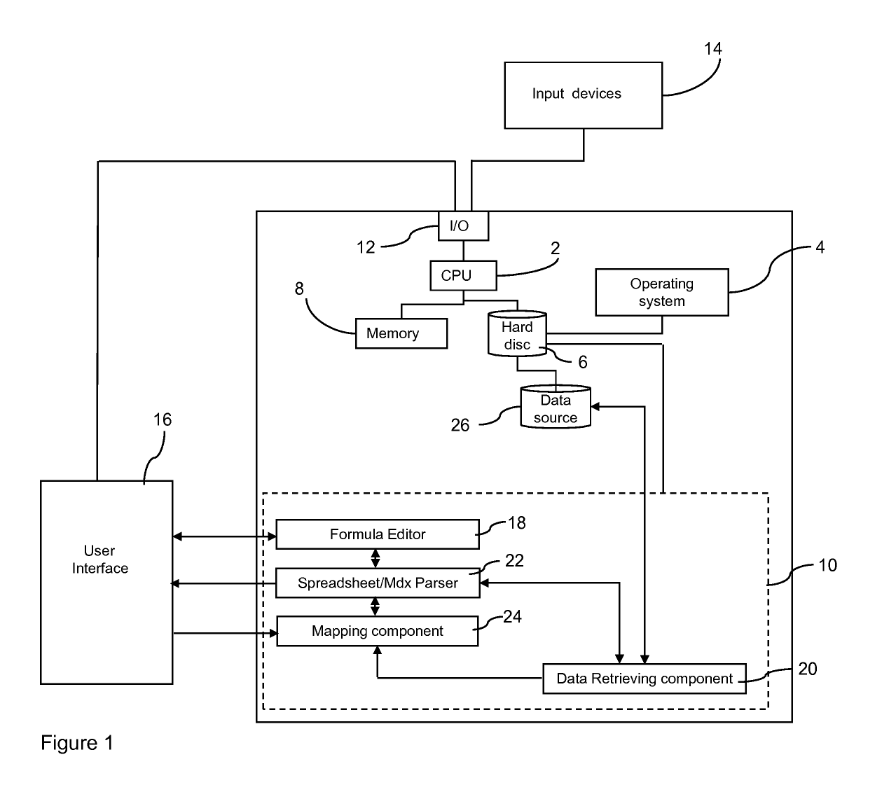

FIG. 1 illustrates a computer system arranged to perform a method in accordance with an embodiment of the present invention. The computer system comprises a central processing unit (CPU) 2, operating system software 4, a hard disc 6, memory 8, an input/output (I/O) system 12, and software 10. In this embodiment, the software 10 comprises a suite of software components 18, 20, 22, 24 operable to carry out a method according to an embodiment of the invention. The I/O system 12 is connected to input devices 14 and a user interface 16 which is operable to display text and images. Input devices 14 may include a keyboard, a mouse, an electronic pen, or a haptic device, which may be used to interact with an image displayed on the user interface 16 in accordance with an embodiment of the invention.

The computer-based method of the present invention will be described when used in association with a data source 26, which in this embodiment is a multidimensional database. Such a database may have been created using the Microsoft SQL Server Analysis Services™ software product. It is to be understood that the data source 26 may be a relational database or any other type of database. By way of example, the data source 26 may store data relating to the financial results of a user's company over several years, in which case the dimensions of the data source 26 comprise at least a Figures dimension and a Time dimension. The Figures dimension comprises a Subject hierarchy, while the Time dimension comprises a Fiscal hierarchy and a Reporting Year hierarchy. The data source 26 may be stored on the hard disc 6 of the computer (as shown) system or on one or more remote servers with which the computer system is capable of exchanging data.

The computer-based method of the present invention which generates a representation of a predetermined query for use in performing the predetermined query will now be described.

Software 10 of the computer system illustrated in FIG. 1 comprises data retrieving software component 20 such as the Microsoft OLAP Provider™ which enables a user to access and extract data from the data source 26. The data retrieved from the data source 26 are displayed in a plurality of uniquely identifiable cells, conveniently represented as a spreadsheet document via the user interface 16; each of the cells is associated with a cell reference and is capable of containing data from the data source 26. The spreadsheet document is preferably created using a spreadsheet application (not shown in FIG. 1) which is comprised in software 10. In the present embodiment, the spreadsheet application is a bespoke spreadsheet application, but a commercially available spreadsheet application such as Microsoft® Excel or Lotus 1-2-3 may alternatively be used.

Software 10 additionally comprises formula editor 18 which enables the user to enter spreadsheet formula within the spreadsheet document. The spreadsheet formula typically comprises a plurality of input cell references and mathematical operators such as add, subtract, multiply, divide. The formula editor 18 may provide functions such as a syntax checking function, a syntax error being for instance highlighted to the user.

In addition, software 10 comprises mapping software component 24, which is capable of mapping each cell reference of a spreadsheet document with a MDX expression, and a spreadsheet/MDX parser 22, which is capable of interacting with the mapping software component 24 and is arranged to analyse spreadsheet formulas entered via the formula editor 18 and to convert these formulas into MDX expressions. The spreadsheet/MDX parser 22 can also convert MDX expressions into spreadsheet formulas.

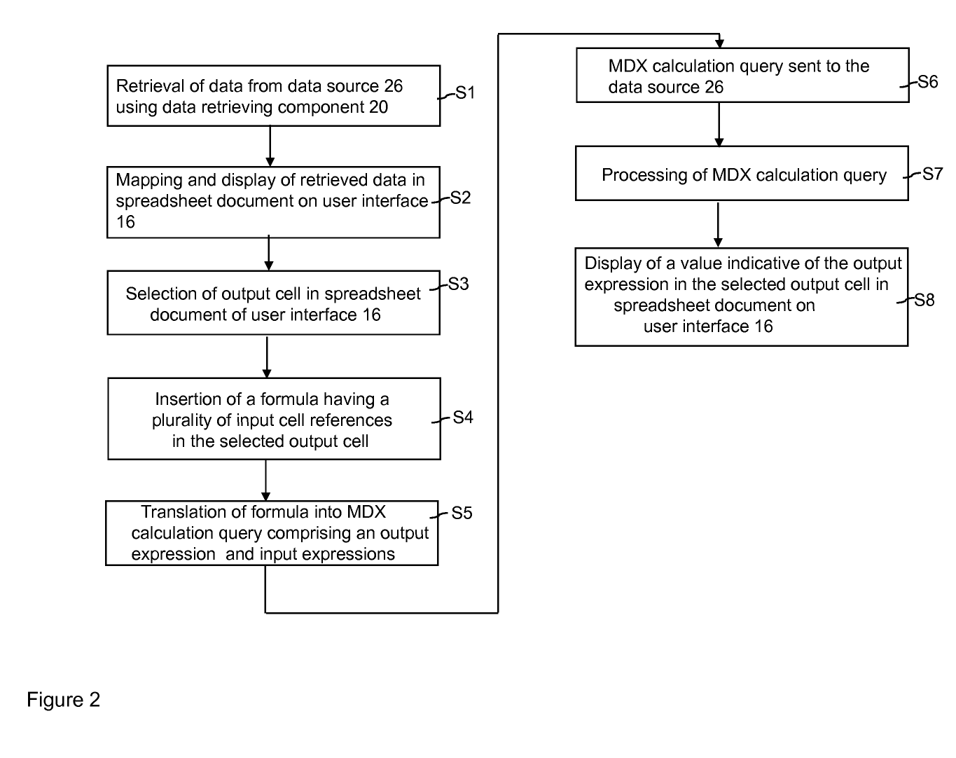

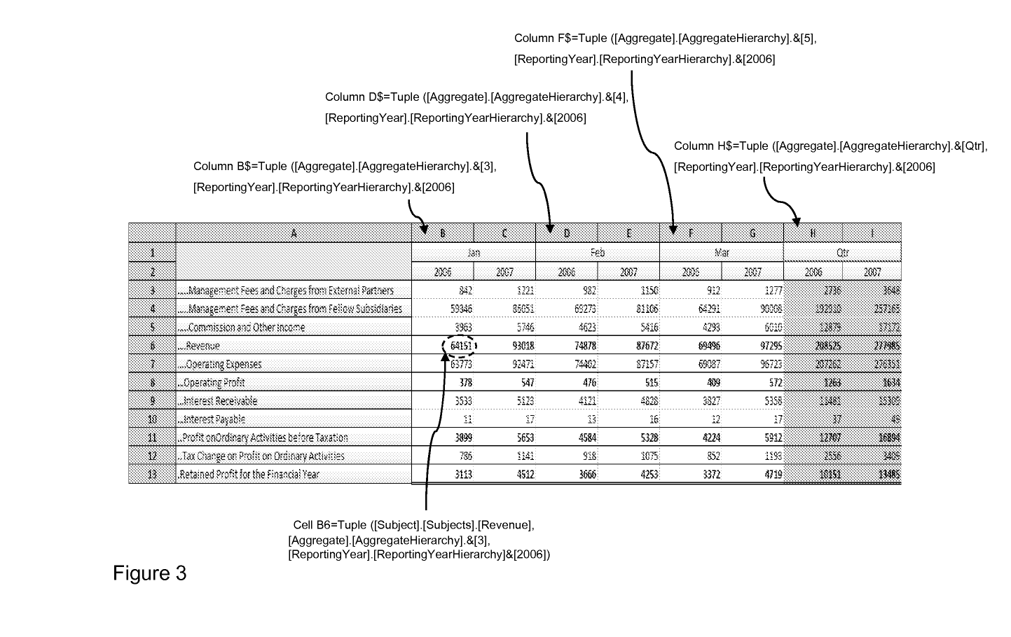

The manner in which the various components of the software 10 interact so as to enable queries to be processed according to embodiments of the invention will now be described with reference to FIGS. 2 and 3, for an example in which a user wishes to visualize his company's monthly financial results for the first quarter of each of the years 2006 and 2007.

Firstly data are retrieved from the data source 26; since the database is an MDX database this is effected by creating a query to retrieve data in the MDX query language. The query can, for example, be constructed on the basis of user selection via the user interface 16 using input devices 14 (e.g. of dimension and hierarchies of interest specified by the user). For example, the user may select the Subject hierarchy of the Figures dimension, and may also select, in the Time dimension, the First Quarter member of the Fiscal hierarchy and the 2006 and 2007 members of the Reporting Year hierarchy.

In response to receipt of such a query, the data retrieving software component 20 retrieves data from the data source 26 in accordance with the selected dimensions (in this example Figures and Time) of the multidimensional database.

In response to the data being retrieved from the data source 26, the retrieved data is processed by the mapping software component 24 and displayed on the user interface 16 in a spreadsheet document, step S2. Alternatively, the retrieved data from the data source 26 may be displayed in a grid on the user interface 16 which may then be labelled with row and column references so as to look like a spreadsheet document.

FIG. 3 shows a screen display of a user interface comprising a spreadsheet document that has been populated with data retrieved from the data source 26 in the manner described above. As can be seen, each of the cells is capable of being referenced by a cell reference, e.g. B6, which comprises a column reference B and a row reference 6. Rows 3 to 13 of the spreadsheet document are labelled with the members of the Subject hierarchy such as Revenue, Operating Profit, etc. Columns B to G of the spreadsheet document are labelled with the hierarchies of the Time dimension, namely the Fiscal hierarchy and the Reporting Year hierarchy. The members of the Fiscal hierarchy (i.e. January, February and March) and the members of the Reporting Year hierarchy (i.e. 2006 and 2007) are shown as column labels. The cells of the spreadsheet document are populated with the data retrieved from the data source 26 in accordance with the dimension and hierarchies of interest selected by the user. From the spreadsheet document of FIG. 3, it can be seen that the Revenue figure for January 2006 is the value 64151 as indicated in cell B6.

So far the query process has progressed much as it would with prior art systems. However, in the event that the user wishes to manipulate the data visualized within the spreadsheet, then with prior art systems, at this point the user would have to define new calculations using the MDX language and assign the calculations to cells in the spreadsheet document. Such a calculation query can be cumbersome and thus error prone since a calculation query using the MDX language typically comprises a combination of many data types.

For example, if a user wishes to calculate an aggregate of his company's financial results for the first quarter of each of the years 2006 and 2007, i.e. from January to March, the user would need to create the following calculation query:

[Aggregate].[AggregateHierarchy].[Qtr]=[Aggregate].[AggregateHierarchy].&[3]+[Aggregate].[AggregateHierarchy].&[4]+[Aggregate].[AggregateHierarchy].&[5]

and enter this query into a cell of the spreadsheet document or by any other means.

Such a calculation query is complex and cumbersome. According to the invention, the user is able to generate a simple representation of this calculation query for use in performing the calculation query, as will now be appreciated from the following example.

Turning back to FIG. 2, with embodiments of the invention, as data are retrieved from the data source 26 and assigned to a cell within the spreadsheet, each cell reference of the spreadsheet document is mapped to an MDX expression by the mapping software component 24 (step S2). By way of example, FIG. 3 shows the MDX expressions which are associated with cell B6 and columns B, D and F. Cell B6 in particular is associated with the following MDX expression:

[Subject].[Subjects].[Revenue],[Aggregate].[AggregateHierarchy].&[3], [ReportingYear].[ReportingYearHierarchy]&[2006]

The user can also define certain cells as comprising combinations of input cells, thereby effectively defining a new query on the basis of data-containing cell references. This process is facilitated by the formula editor 18, which enables the user to label certain cells as output cells and then associate them with cells populated with data at step S2 (referred to as “input cells”). Referring to FIG. 3, in this instance, the user may enter the formula “B$+D$+F$” (B$, D$, F$ being the input cell references) for insertion in the output cell Qtr (step S4 in FIG. 2). Alternatively, the user may enter the formula as “B$:C$+D$:E$+F$:G$” or “B$, D$, F$”. The user may also select the plurality of input cell references by clicking on the January, February and March cells of the spreadsheet document in this particular order. As a response, the formula “B$+D$+F$” may automatically be entered in the formula editor 18 into the cells within columns H and I. The cells corresponding to columns H and I are recognized by the formula editor 18 as corresponding to output cell because the user enters data indicative of cell references containing data imported at step S1.

The spreadsheet formula is then parsed by the spreadsheet/MDX parser 22 in conjunction with the mapping software component 24 and the formula is translated into an MDX calculation query comprising an output expression and a plurality of input expressions, step S5.

In this particular example, the spreadsheet/MDX parser 22 and the mapping software component 24 would map:

the input cell reference B$ of the formula to the input expression of the calculation query [Aggregate].[AggregateHierarchy].&[3];

the input cell reference D$ of the formula to the input expression of the calculation query [Aggregate].[AggregateHierarchy].&[4]; and

the input cell reference F$ of the formula to the input expression of the calculation query [Aggregate].[AggregateHierarchy].&[5].

and the MDX calculation query is as follows:

[Aggregate].[AggregateHierarchy].[Qtr]=[Aggregate].[AggregateHierarchy].&[3]+[Aggregate].[AggregateHierarchy].&[4]+[Aggregate].[AggregateHierarchy].&[5]

The MDX calculation query is transmitted to the data source 26 via the data retrieving software component 20, step S6, and then executed in the data source 26, step S7. The result of the MDX calculation query is then returned by the data source 26 and a value indicative of the output expression is displayed in the selected output cell of the spreadsheet document, step S8.

An example is shown in FIG. 3 where an aggregate of the company's financial results for the first quarter of each of the years 2006 and 2007 is displayed in columns H and I.

### Additional and Implementation Details

Whilst in the above embodiments, the software 10 comprises four software components 18, 20, 22, 24 operable to carry out a method according to an embodiment of the invention, the software 10 may comprise less or more than four software components to carry out the method.

Whilst in the above embodiments the mapping component 24 maps cell references to MDX expressions by porting the MDX expressions into the spreadsheet, embodiments of the invention could alternatively operate so as to enable a user to select MDX expressions from the data source 26 and send data indicative of cell references to be associated with selected MDX expressions to the data source 26. In this way, when a combination of cell references are entered into a given output cell, the spreadsheet formula would be transmitted to the data source 26 and thence mapped to a corresponding MDX expression.

The above embodiments are to be understood as illustrative examples of the invention. Further embodiments of the invention are envisaged. For example, the data source may be a relational database or any other type of database. Also, query languages other than the MDX language may be used, such as the Structured Query Language (SQL). It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. A computer-based method for generating a representation of a query for use in performing said query, the method comprising the steps of:
(a) retrieving data from a data source;
(b) displaying said retrieved data in a plurality of cells, each of said plurality of cells being associated with a cell reference and being capable of containing data from said data source, each cell reference being associated with an expression formulated in a predetermined query language;
(c) receiving data indicative of an output cell selected from said plurality of cells;
(d) receiving data indicative of a formula for insertion in said selected output cell, said formula comprising a plurality of input cell references, each relating to one of said cells; and
(e) converting said formula into a calculation query comprising an output expression and a plurality of input expressions by replacing each of said input cell references in said formula by its associated expression, whereby to generate a representation of said calculation query.

2. A computer-based method according to claim 1, further including performing said calculation query and displaying, in said selected output cell, a value indicative of said output expression.

3. A computer-based method according to claim 1, including
receiving data indicative of a range of output cells selected from said plurality of cells;
receiving data indicative of a formula for insertion in said selected range of output cells; and
performing said calculation query and displaying, in said selected range of output cells, a value indicative of said output expression.

4. A computer-based method according to claim 1, including displaying said data retrieved from said data source in a grid on a user interface and labeling said table with row and column references, each of said cell references comprising a row reference and column reference, whereby to display said retrieved data in a spreadsheet document.

5. A computer-based method according to claim 1, including retrieving data from a relational database.

6. A computer-based method according to claim 5, said predetermined query language being the SQL language.

7. A computer-based method according to claim 1, including retrieving data from a multidimensional database.

8. A computer-based method according to claim 7, said predetermined query language being the MDX language.

9. A computer program product comprising a computer-readable medium having computer readable instructions recorded thereon, said computer program product being adapted to perform a query, the computer readable instructions being operative, when performed by a computer, or a suite of computers, to cause the computer to:
(a) retrieve data from a data source;
(b) display said retrieved data in a plurality of cells, each of said plurality of cells being associated with a cell reference and being capable of containing data from said data source, each cell reference being associated with an expression formulated in a predetermined query language;
(c) receive data indicative of an output cell selected from said plurality of cells;
(d) receive data indicative of a formula for insertion in said selected output cell, said formula comprising a plurality of input cell references, each relating to one of said cells;
(e) convert said formula into a calculation query comprising an output expression and a plurality of input expressions by replacing each of said input cell references in said formula by its associated expression; and
(f) perform said calculation query and display, in said selected output cell, a value indicative of said output expression.

10. A system for generating a representation of a query for use in performing said query, the system comprising:
a data source arranged to hold a plurality of expressions formulated in a predetermined query language;
an interface for retrieving data from said data source;
a user interface for displaying said retrieved data in a plurality of cells, each of said plurality of cells being associated with a cell reference and being capable of containing data from said data source, each cell reference being associated with one of said expressions;
a processing system in operative association with said user interface, wherein the processing system is capable of receiving data indicative of an output cell selected via said user interface and data indicative of a formula for insertion in said selected output cell, said formula comprising a plurality of input cell references, each relating to one of said cells;
wherein the processing system is arranged to convert said formula into a calculation query comprising an output expression and a plurality of input expressions by replacing each of said input cell references in said formula by its associated expression.

11. A system according to claim 10, wherein the processing system is arranged to perform said calculation query and the user interface is arranged to display, in said selected output cell, a value indicative of said output expression.
